(19) United States
(12) Patent Application Publication
(10) Pub. No.: US 2008/0259171 A1
(43) Pub. Date: Oct. 23, 2008

(54) SYSTEM AND METHOD FOR COMPENSATING OFFSET OF A SOLID-STATE IMAGING DEVICE

(75) Inventors: Chih-Yang Chiang, Taichung (TW); Te-Tean Kao, Taichung (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASIA OPTICAL CO., INC., Taichung (TW)

(21) Appl. No.: 11/940,465

(22) Filed: Nov. 15, 2007

(30) Foreign Application Priority Data
Apr. 23, 2007 (TW) 96114275

(51) Int. Cl. H04N 5/217

(52) U.S. Cl. 348/208.7; 348/E05.079

(57) ABSTRACT

A method for compensating an offset of a solid-state imaging device includes obtaining a detection signal representing the offset of the solid-state imaging device disposed on a stage, generating a corresponding control voltage and control signal according to the detection signal; generating a corresponding regulation voltage according to the control voltage, generating a corresponding driving voltage according to the regulation voltage, outputting a driving signal according to the driving voltage and the control signal, and generating a magnetic force according to the driving signal to move the stage.

### BACKGROUND OF THE INVENTION

1. Field of the Invention

The invention relates to a compensating system and method of a photoing device, and more particularly to a system and method for compensating offset of a solid-state imaging device.

2. Description of the Related Art

Generally, shakes for photoing images are common, especially for light and thin digital cameras. Human ability to hold a digital camera stable is insufficient such that the camera vibrates when the hand shakes or the shutter is indented by pressure from the user's finger, resulting in blurred images.

An angular velocity sensor and a position detection sensor are usually installed in a photoing device to detect angle variation data and position variation data while the photoing device is moving, generating corresponding detection signals. The angular velocity sensor, such as a gyro sensor, can detect angles, angle velocities, or angle acceleration variations of the photoing device while the photoing device is operating, while the position sensor, such as a Hall Effect sensor, can detect movement increment of the photoing device while the photoing device is operating.

Additionally, a motor driver and an inductance coil are installed in the photoing device. The motor driver is controlled using pulse width modulation (PWM) signals to output fixed voltages. The inductance coil is driven by regulating duty cycles of the PWM signals and generates a magnetic force to compensate the tremble direction and shifting amount of a lens, solving the vibration discrepancy of the photoing device while picturing.

The described process however, outputs fixed voltage within a predetermined period for driving the motor driver. Specifically, the voltage is unable to immediately change output voltages to the motor driver according to different detected detection signals. Thus, wasting power and providing inefficient compensations.

The invention provides a system and method for compensating offset of a solid-state imaging device, overcoming blurred images generated due to vibrations, reducing power waste, and providing efficient compensations.

### BRIEF SUMMARY OF THE INVENTION

The invention provides methods for compensating offset of a solid-state imaging device. An exemplary embodiment of a method for compensating offset of a solid-state imaging device compensates the offset of the solid-state imaging device disposed on a stage by regulating the stage, comprises the following. A detection signal representing offset of the photoing device while operating is obtained. Corresponding control voltage and control signal are generated according to the detection signal. A corresponding regulation voltage is generated according to the control voltage. A corresponding driving voltage is generated according to the regulation voltage. A driving signal is output according to the driving voltage and the control signal. A magnetic force is generated according to the driving signal to move the stage.

The invention further provides systems for compensating offset of a solid-state imaging device of a photoing device. An exemplary embodiment of a system for compensating offset of a solid-state imaging device of a photoing device compensates the offset of the solid-state imaging device disposed on a stage by regulating the stage, comprising a detection device, a micro-control device, a voltage regulating circuit, a voltage regulating device, an electric machinery driving device, and a magnetic energy device. The detection device detects offset of the photoing device while operating to generate a corresponding detection signal. The micro-control device generates a corresponding control voltage and control signal according to the detection signal. The voltage regulating circuit electrically couples to the micro-control device and generates a corresponding regulation voltage according to the control voltage. The voltage regulating device electrically couples to the voltage regulating circuit and generates a corresponding driving voltage according to the regulation voltage. The electric machinery driving device is driven by the driving voltage and controlled by the control signal from the micro-control device to output a driving signal. The magnetic energy device electrically couples to the electric machinery driving device and receives the driving signal to generate a magnetic force to move the stage.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of an embodiment of a system for compensating offset of a solid-state imaging device;

FIG. 2 is a schematic view of an embodiment of a voltage regulation circuit;

FIG. 3 is a schematic view of current trends based on a direct current voltage for the top half of the voltage regulation circuit shown in FIG. 2;

FIG. 4 is a schematic view of current trends based on another direct current voltage for the top half of the voltage regulation circuit shown in FIG. 2; and

FIG. 5 is a flowchart of an embodiment of a method for compensating offset of a solid-state imaging device.

### DETAILED DESCRIPTION OF THE INVENTION

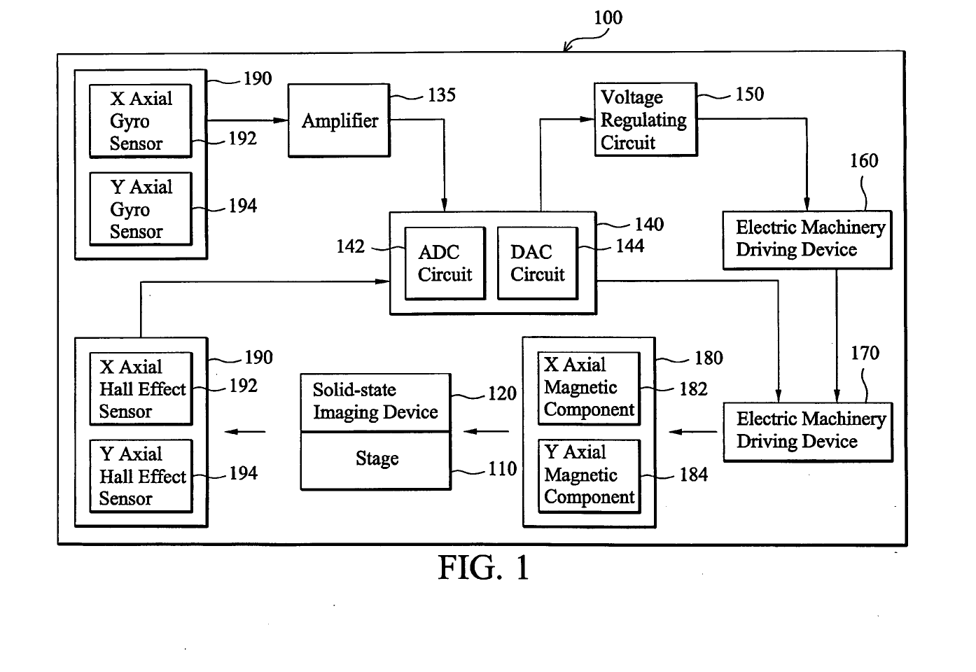

Several exemplary embodiments of the invention are described with reference to FIGS. 1 through 5, which generally relate to method and system for compensating offset of a solid-state imaging device. It is to be understood that the following disclosure provides various different embodiments as examples for implementing different features of the invention. Specific examples of components and arrangements are described in the following to simplify the present disclosure. These are merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses a system and method for compensating offset of a solid-state imaging device.

FIG. 1 is a schematic view of an embodiment of a system for compensating offset of a solid-state imaging device.

The system is installed in a photoing device 100 and compensates offset of a solid-state imaging device 120 disposed on a stage 110. Solid-state imaging device 120 can be a charge coupled device (CCD).

The system comprises a vibration detection device 130, an amplifier 135, a micro-control device 140, a voltage regulating circuit 150, a voltage regulating device 160, an electric machinery driving device 170, and a magnetic energy device 180, and a position detection device 190. Vibration detection device 130 detects offset due to vibrations of photoing device 100 while operating and generates a corresponding detection signal. Vibration detection device 130 further comprises an X axial tilting signal sensor, and a Y axial tilting signal sensor, such as X axial gyro sensor 132 and Y axial gyro sensor 134, detecting angle offset of photoing device 100 along X and Y axes.

Amplifier 135 amplifies and transmits the detected detection signal from vibration detection device 130 to micro-control device 140 for operations. Micro-control device 140 generates a corresponding control voltage and a corresponding control signal according to the detection signal. Micro-control device 140 further comprises an analog to digital conversion (ADC) circuit 142 and a digital to analog conversion (DAC) circuit 144.

ADC circuit 142 converts the amplified detection signal by amplifier 135 to a digital signal. DAC circuit 144 converts the digital signal to a control voltage and outputs the control signal when digital signal processing is complete.

Voltage regulating circuit 150 electrically couples to micro-control device 140 and generates a corresponding regulation voltage according to the control voltage generated by micro-control device 140. Voltage regulating device 160 electrically couples to voltage regulating circuit 150 and generates a corresponding driving voltage according to the regulation voltage generated by voltage regulating circuit 150.

Next, electric machinery driving device 170, such as a motor driver, is driven by the driving voltage and controlled by the control signal from micro-control device 140 to output a driving signal to drive magnetic energy device 180. Drive magnetic energy device 180 electrically couples to the electric machinery driving device 170 and is driven to generate a magnetic force to move stage 110, achieving compensations. Drive magnetic energy device 180 further comprises an X axial magnetic component 182 and a Y axial magnetic component 184, regulating stage 110 along the X and Y axes. Each of magnetic components 182 and 184 comprises an inductance coil and a magnet respectively.

When stage 110 is driven, pushed by the magnetic force, position detection device 190 detects position variations of stage 110 and outputs and transmits a corresponding position signal to micro-control device 140 for operations. Position detection device 190 further comprises an X axial Hall Effect sensor 192 and a Y axial Hall Effect sensor 194, detecting position offset along the X and Y axes of stage 110. When processing the position detection signal output by position detection device 190 is complete, micro-control device 140 re-controls electric machinery driving device 170 according to the processing result and drives magnetic energy device 180 to regulate the position of stage 110 that corresponds to offset of stage 110 which is detected by vibration detection device 130.

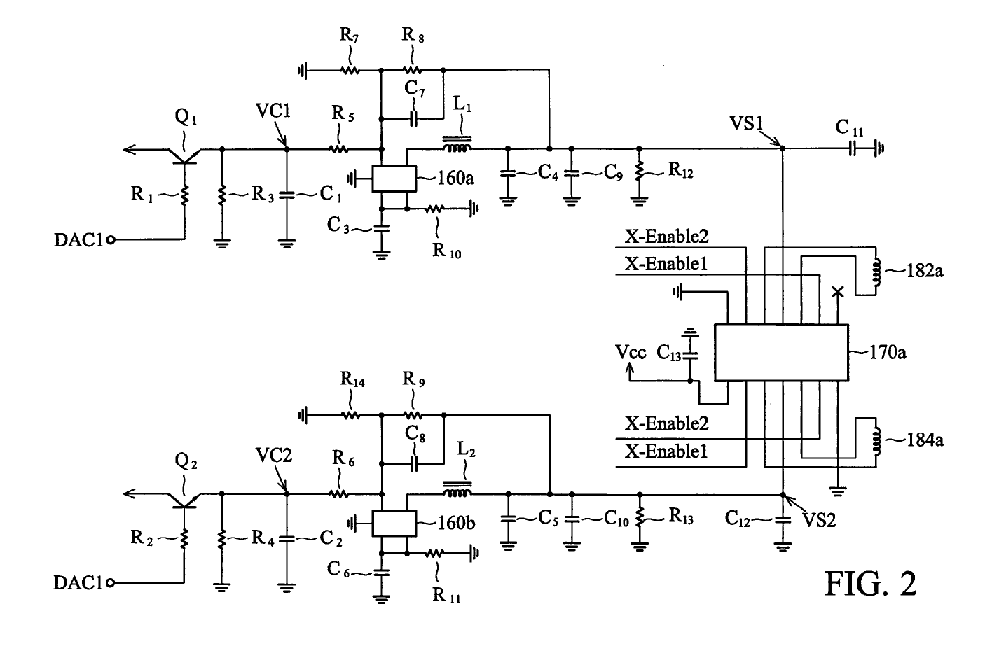

FIG. 2 is a schematic view of an embodiment of a voltage regulation circuit.

The voltage regulation circuit comprises top and bottom half portions, generating regulation voltage VC1 and VC2 according to direct current voltages DAC1 and DAC2, respectively, generated by DAC circuit 144 shown in FIG. 1 and generating driving voltages VS1 and VS2 according to voltage regulation devices 160a and 160b, respectively. Next, driving signals are generated according to driving voltages VS1 and VS2, respectively, using electric machinery driving device 170a, driving X axial magnetic component 182a and Y axial magnetic component 182a to regulate stage 110. In this embodiment, the voltage regulation circuit comprises bipolar junction transistors (BJT) Q1 and Q2.

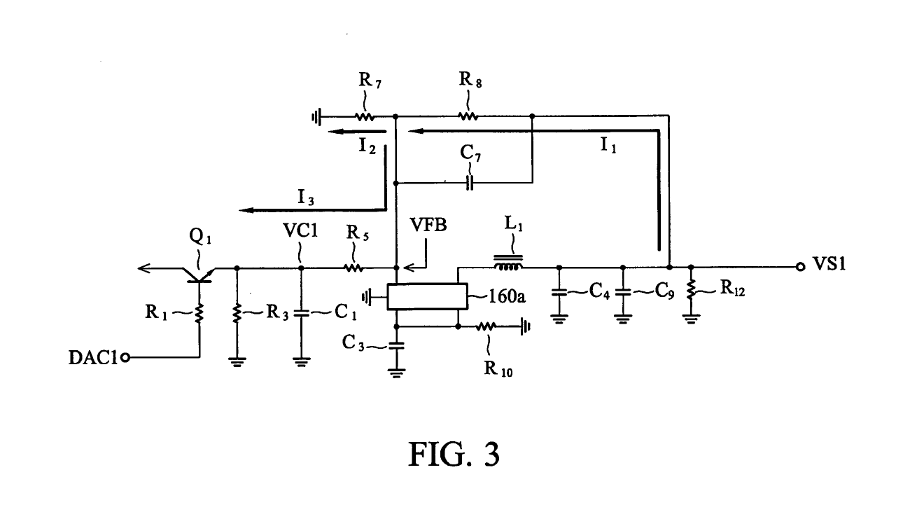

FIG. 3 is a schematic view of current trends based on a direct current voltage for the top half of the voltage regulation circuit shown in FIG. 2.

Only the top half portion of the voltage regulation circuit, which the layout thereof is identical to that of the bottom half portion, is illustrated for simplicity. Referring to FIG. 3, the voltage VFB is a feedback input voltage of voltage regulation devices 160a, comprising an internal comparison voltage 0.8V. When voltage VC1 is equal to VFB, I₃=0, I₁=I₂, so I₂=(0.8/R7), and VS1=(R7+R8)×I₂=(R7+R8)×(0.8/R7)=0.8+(R8/R7)×0.8.

When VC1 is less than VFB, I₁=I₂+I₃, I₃=(0.8−VC1)/R5, and I₂=(0.8/R7), so VS1=R7×I₂+R8×I₁=R7×(0.8/R7)+R8×(I₂+I₃)=0.8+R8×(0.8/R7)+R8×(0.8−VC1)/R5=0.8+(R8/R7)×0.8+R8×(0.8−VC1)/R5. Thus, driving voltage VS1 provides different values due to the change of voltage VC1. That is to say, multiple driving voltages VS1 are generated according to the change of direct current voltage DAC1 to immediately change driving signals and magnetic forces generated by magnate force components.

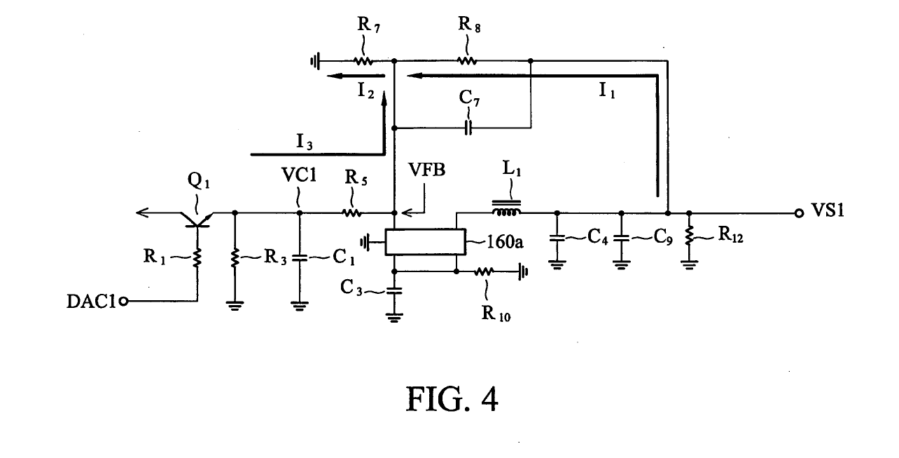

FIG. 4 is a schematic view of current trends based on another direct current voltage for the top half of the voltage regulation circuit shown in FIG. 2.

When VC1 is greater than VFB, I₁=I₂−I₃, I₃=(VC1−0.8)/R5, and I₂=(0.8/R7), so VS1=R7×I2+R8×I₁=R7×(0.8/R7)+R8×(I₂−I₃)=0.8+R8×(0.8/R7)−R8×(VC1−0.8)/R5=0.8+(R8/R7)×0.8−R8×(VC1−0.8)/R5. Thus, driving voltage VS1 also provides different values due to the change of voltage VC1. That is to say, multiple driving voltages VS1 are generated according to the change of direct current voltage DAC1 to immediately change driving signals and magnetic forces generated by magnate force components. Thus, regardless of the value of direct current voltage DAC1, driving voltage VS1 can be regulated based on the change of voltage VC1, changing the magnetic force of the magnetic energy component to control the shifting speed of the stage.

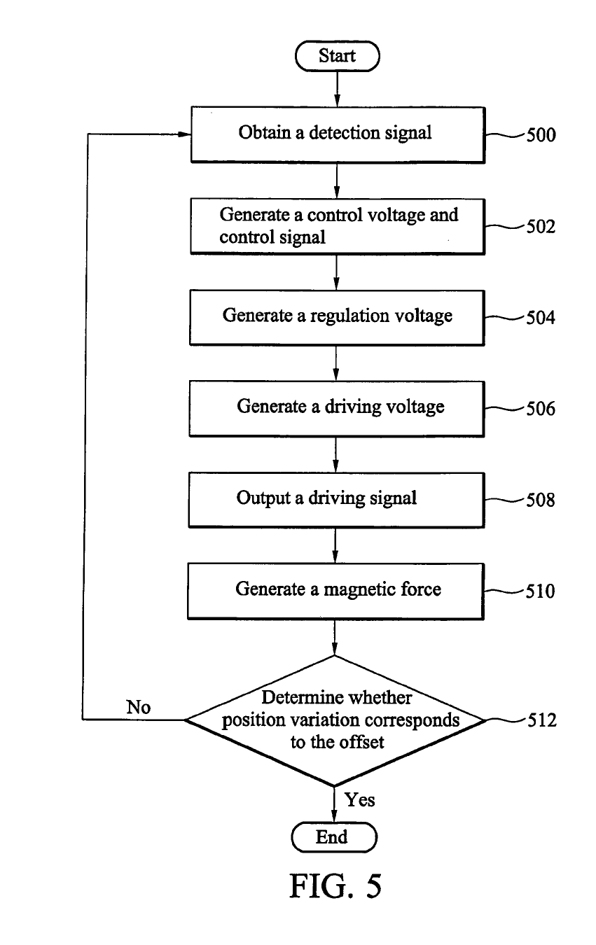

FIG. 5 is a flowchart of an embodiment of a method for compensating offset of a solid-state imaging device.

A detection signal is obtained (step 500). The detection signal represents offset of the photoing device due to vibrations while the photoing device is operating, comprising X and Y axial offset data of the photoing device. Corresponding control voltage and control signal are generated according to the detection signal (step 502). The detection signal can be converted to a digital signal and then a control voltage. Next, a corresponding regulation voltage is generated according to the control voltage (step 504). A corresponding driving voltage is generated according to the regulation voltage (step 506). A driving signal is outputed according to the driving voltage and the control signal (step 508). A magnetic force is generated according to the driving signal to regulate the stage in the X and Y axial directions (step 510).

Additionally, when the stage is regulated by the magnetic force, it is then determined whether position variation of the stage corresponds to the offset of the photoing device (step 512). If the position variation corresponds to the offset, the process terminates. If the position variation does not correspond to the offset, the process proceeds to step 500 to obtain another detection signal, positions the detection signal representing the varied position of the stage. Next, a second control signal is generated according to the position detection signal (step 502). Next, the second control voltage is converted to a regulation voltage (step 504), and a corresponding driving voltage is generated (step 506). A second driving signal is outputed according to the driving voltage and the second control signal (step 508). A second magnetic force is generated according to the second driving signal to regulate the stage (step 510), enabling the regulation of the stage to correspond to the offset of the photoing device.

An embodiment of a system and method for compensating offset of a solid-state imaging device provides an optical image stabilizer to constrain blurred images generated by vibrations and generates multiple driving voltages according to detected detection signals, reducing power waste and providing efficient compensations.

Methods and systems of the present disclosure, or certain aspects or portions of embodiments thereof, may take the form of a program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for compensating offset of a solid-state imaging device of a photoing device and compensating the offset of the solid-state imaging device disposed on a stage by regulating the stage, comprising:
a detection device, detecting the offset of the photoing device while operating to generate a corresponding detection signal;
a micro-control device, generating a corresponding control voltage and control signal according to the detection signal;
a voltage regulating circuit, generating a corresponding regulation voltage according to the control voltage;
a voltage regulating device, generating a corresponding driving voltage according to the regulation voltage;
an electric machinery driving device, driven by the driving voltage and controlled by the control signal from the micro-control device to output a driving signal; and
a magnetic energy device, receiving the driving signal to generate a magnetic force to move the stage.

2. The system for compensating offset of a solid-state imaging device as claimed in claim 1, further comprising a position detection device, detecting position variations of the stage to output a corresponding position detection signal to the micro-control device for operations.

3. The system for compensating offset of a solid-state imaging device as claimed in claim 2, wherein the position detection device further comprises:
a first position sensor, detecting offset along the X axis of the stage; and
a second position sensor, detecting offset along the Y axis of the stage.

4. The system for compensating offset of a solid-state imaging device as claimed in claim 3, wherein the first and second position sensors are Hall Effect sensors.

5. The system for compensating offset of a solid-state imaging device as claimed in claim 2, wherein the micro-control device processes the position detection signal and controls the electric machinery driving device to drive the magnetic energy device.

6. The system for compensating offset of a solid-state imaging device as claimed in claim 1, wherein the detection device further comprises:
a first sensor, detecting offset along the X axis of the photoing device; and
a second sensor, detecting offset along the Y axis of the photoing device

7. The system for compensating offset of a solid-state imaging device as claimed in claim 6, wherein the first and second sensors are tilting signal sensors.

8. The system for compensating offset of a solid-state imaging device as claimed in claim 7, wherein the tilting signal sensors are gyro sensors.

9. The system for compensating offset of a solid-state imaging device as claimed in claim 1, wherein the micro-control device further comprises an analog to digital conversion circuit, converting the detection signal to a digital signal.

10. The system for compensating offset of a solid-state imaging device as claimed in claim 9, wherein the micro-control device further comprises a digital to analog conversion circuit, converting the digital signal to the control voltage.

11. The system for compensating offset of a solid-state imaging device as claimed in claim 1, wherein the voltage regulating circuit further comprises a bipolar junction transistor, generating the regulation voltage according to the control voltage.

12. The system for compensating offset of a solid-state imaging device as claimed in claim 1, wherein the electric machinery driving device is a motor driver.

13. The system for compensating offset of a solid-state imaging device as claimed in claim 1, wherein the magnetic energy device further comprises:
a first magnetic energy component, regulating the stage along the X axis; and
a second magnetic energy component, regulating the stage along the Y axis.

14. The system for compensating offset of a solid-state imaging device as claimed in claim 13, wherein each of the first and second magnetic energy components comprises an inductance coil and a magnet respectively.

15. The system for compensating offset of a solid-state imaging device as claimed in claim 1, wherein the solid-state imaging device is a charge coupled device.

16. A method for compensating offset of a solid-state imaging device, compensating the offset of the solid-state imaging device disposed on a stage by regulating the stage, comprising:
obtaining a detection signal representing offset of the photoing device while operating;
generating a corresponding control voltage and first control signal according to the detection signal;
generating a corresponding regulation voltage according to the control voltage;
generating a corresponding driving voltage according to the regulation voltage;
outputting a first driving signal according to the driving voltage and the first control signal; and
generating a first magnetic force according to the first driving signal to move the stage.

17. The method for compensating offset of a solid-state imaging device as claimed in claim 16, further comprising:
determining whether position variation of the stage corresponds to the offset of the photoing device;
if the position variation does not correspond to the offset, obtaining a position detection signal representing the position variation of the stage;
generating a second control signal according to the position detection signal;
outputting a second driving signal according to the driving voltage and the second control signal; and
generating a second magnetic force according to the second driving signal to move the stage.

18. The method for compensating offset of a solid-state imaging device as claimed in claim 16, further comprising:
converting the detection signal to a digital signal; and
converting the digital signal to the control voltage.

19. The method for compensating offset of a solid-state imaging device as claimed in claim 16, wherein the detection signal comprises X and Y axial offset data of the photoing device.

20. The method for compensating offset of a solid-state imaging device as claimed in claim 16, further comprising regulating the stage along the X and Y axes according to the magnetic forces generated based on the driving signals.
